(19) United States
(12) Patent Application Publication
(10) Pub. No.: US 2014/0268719 A1
(43) Pub. Date: Sep. 18, 2014

(54) Modular LED Fluorescent Tube Structure with Replaceable Modules

(71) Applicant: Ming-Yuan WU, Tiapei (TW)

(72) Inventor: Ming-Yuan WU, Tiapei (TW)

(21) Appl. No.: 13/798,039

(22) Filed: Mar. 12, 2013

(51) Int. Cl. F21K 99/00

(52) U.S. Cl. CPC F21K 9/10
USPC 362/218

(57) ABSTRACT

A modular LED fluorescent tube structure includes a heat dissipating holder, a light emitting plate and a driver module. The light emitting plate is disposed in the heat dissipating holder, which includes a cover for protection. The driver module is disposed on one side of the heat dissipating holder and to be connected electrically to the light emitting plate. The connector is detachable and may be replaced to different types. Moreover, the light emitting plate is also detachable. Therefore, the maintenance cost of the LED fluorescent tube is reduced to achieve cost-effectiveness and environment protection.

### BACKGROUND OF THE INVENTION

1. Field of Invention

The invention relates to lamps and, in particular, to LED tubular lamps which have one or more LEDs as light sources and which can replace a fluorescent tube.

2. Related Art

Fluorescent lamps are widely used in different environments, such as in homes, offices and industry. Fluorescent lamps are more durable, economical and efficient than incandescent lamps, in which most of the electric power generates heat rather than light. In a conventional fluorescent lamp, the body is a straight tube with a length of 15 to 60 times the diameter of the tube. The tube may also be bent, in which case it may be of almost any shape. Fluorescent tubes are low-pressure mercury discharge lamps in which the inner surface of the tube is coated with a fluorescent material.

Although the aforementioned conventional lamp has the advantages of low cost and convenient maintenance, yet the fluorescent tube also comes with the drawbacks of high power consumption and short lifetime. As a result, the overall cost of the conventional lamp is increased. The energy saving issue gradually becomes an important topic, and each government will prohibit incandescent lamp in the near future to cause a new illumination option, especially for LEDs. The LED having advantages of high efficiency, energy saving and dimming adjustable has been gradually applied to road lamps, vehicle lamps and outdoor illumination and scenario illumination in the illumination market.

A common aim is to replace fluorescent tubes with LED tubular lamps having the same length and values. In these, the physical dimensions are the same as in straight fluorescent tubes (e.g. T8 with a diameter of 26 mm and a length of 60 or 120 cm), whereby the fluorescent tube could be directly replaced with a LED tube in an existing fluorescent tube lighting fixture.

### SUMMARY OF THE INVENTION

The present invention overcomes the above-described and other problems and disadvantages in the prior art by providing a LED fluorescent tube with simplified structure to mass-produce easily with cost down and to enable rapid repair and maintenance.

A major objective of the present invention is to provide a modular LED fluorescent tube, wherein, the modules, such as a light emitting plate, or a driver module, can be replaced when they break down, without having to discard the whole set of LED fluorescent tube, thus eliminating the unnecessary waste, in achieving cost-effectiveness and environment protection.

Accordingly, the present invention provides a LED fluorescent tube structure including a heat dissipating holder, a light emitting plate and a driver module. The light emitting plate is disposed in and contacted to the heat dissipating holder. The driver module is detachably disposed on one side of the heat dissipating holder and electrically connected to the light emitting plate. Therefore, the rapid repair and maintenance is permitted.

Also, the light emitting plate and the driver module are changeable when they break down, without having to discard the whole set of LED fluorescent tube structure, thus eliminating the unnecessary waste, in achieving cost-effectiveness and environment protection.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIGS. 1A and 1B are perspective views of a LED fluorescent tube structure of a first preferred embodiment of the present invention;

FIGS. 2A and 2B are side views of a LED fluorescent tube structure of a first preferred embodiment of the present invention;

FIGS. 3A and 3B are schematic views of a detachable light emitting plate in accordance with a preferred embodiment of the LED fluorescent tube structure of FIG. 1A;

FIG. 4 is schematic view of a detachable light emitting plate in accordance with another embodiment of the LED fluorescent tube structure of FIG. 1A;

FIGS. 5A and 5B are perspective views of a LED fluorescent tube structure of a second preferred embodiment of the present invention; and

FIG. 6 is perspective view of a LED fluorescent tube structure of a third preferred embodiment of the present invention.

### DETAILED DESCRIPTION OF THE INVENTION

A LED fluorescent tube structure of a first embodiment of the present invention is shown in FIGS. 1A and 1B. The LED fluorescent tube 1 includes a heat dissipating holder 10, a light emitting plate 20 and a driver module 30. The light emitting plate 20 is disposed in and contacted to the heat dissipating holder 10. The driver module 30 is detachably disposed on one side of the heat dissipating holder 10 and electrically connected to the light emitting plate 20. The driver module 30 is configured to receive input power from an AC power source such as a commercial power source or from a DC power source such as a battery, to convert the input power into required DC power, and output the required DC power to the light emitting plate 20. The driver module 13 may also be adapted to control or regulate the total current for the light emitting plate 20.

The driver module 30 includes a contact pin pair 31 at one end and a fastening element 33 for detachably connection to a fixing hole 12 of the heat dissipating holder 10 at the other end. The heat dissipating holder 10 includes a cover 11 to cover the light emitting plate 20 for protection. The cover 11 is a translucent cover to be penetrated by the light emitted by the light emitting plate 20. The heat dissipating holder 10 also includes contact pin pair 13 on the other side. The heat dissipating holder 10 may be made of metal materials of high thermal conductivity such as copper and aluminum.

Please refer to FIGS. 2A and 2B, the light emitting plate 20 includes a plurality of LEDs disposed thereon and configured to emit lights. The LEDs may be a surface mounting device (SMD) or have a chip on board (COB) package structure. The light emitting plate 20 further includes a connecting hole 21 in one end and a connecting plate 22 on a backside. The driver module 30 further includes a connecting pin 32. The connecting pin 32 of the driver module 30 is electrically connected to the connecting hole 21 of the light emitting plate 20. The required DC power is transmitted to the light emitting plate 20 through the connecting pin 32 and the connecting hole 21. The connecting plate 22 is configured to connect and contact to the heat dissipating holder 10 to improve heat dissipation. The connecting plate 22 may be a magnetic connecting plate. Furthermore, the connecting plate 22 may also be connected by springs, screws or tight-fitting.

Please see FIGS. 3A and 3B, the driver module 30 is detachably connected to the heat dissipating holder 10. The light emitting plate 20 may be drawn out from this side when the driver module 30 is detached. Therefore, the driver module 30 and the light emitting plate 20 can be replaced when they break down, without having to discard the whole set of the LED fluorescent tube 1. Thus, the unnecessary waste is eliminated to achieve cost-effectiveness and environment protection. On the other hand, the cover 11 may be detached from the heat dissipating holder 10, please refer to FIG. 4. The light emitting plate 20 can be replaced without taking off the driver module 30.

As shown in FIG. 5A, the LED fluorescent tube 1 further comprises a connector 40 with a contact pin pair 13 disposed on another side of the heat dissipating holder 10. The connector 40 is detachably connected to the heat dissipating holder 10. Therefore, the connector 40 can also be replaced. Moreover, as shown in FIG. 5B, the LED fluorescent tube 1 includes two connectors 40 and 41 with a contact pin pair 13 and 31 respectively. The connectors 40, 41 are disposed on both sides of the heat dissipating holder 10. Therefore, the connectors 40, 41 may be replaced with other connectors corresponding with the standard, such as T-4, T-5, T-8, T-10 or T-12.

Please refer to FIG. 6, in case of the LED fluorescent tube 1 receives the required DC power directly, rather than the commercial AC power source. The LED fluorescent tube 1 only includes a heat dissipating holder 10, a light emitting plate 20 and two connectors 40 and 41. The driver module 30 is not necessary. Also, the connectors 40, 41 may be replaceable.

Moreover, the modular design of the LED fluorescent tube structure eases maintenance and tends to lower costs of maintenance as a failed light emitting plate 20, or a driver module 30 is easy to replace and is less expensive to replace than replacement of the entire lamp.

Accordingly, the present invention provides a LED fluorescent tube structure with reduced maintenance cost and simplified maintenance process. The modular design of the LED fluorescent tube structure eases maintenance and tends to lower costs of maintenance as a failed light emitting plate, or a driver module is easy to replace and is less expensive to replace than replacement of the entire lamp.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A LED fluorescent tube structure, comprising:
a heat dissipating holder;
a light emitting plate, disposed in and contacted to the heat dissipating holder; and
a driver module, detachably disposed on one side of the heat dissipating holder and electrically connected to the light emitting plate, the driver module includes a contact pin pair at one end.

2. The LED fluorescent tube structure of claim 1, wherein the driver module further includes a fastening element for detachably connection to the heat dissipating holder.

3. The LED fluorescent tube structure of claim 1, wherein the light emitting plate includes a connecting plate to connect and contact to the heat dissipating holder.

4. The LED fluorescent tube structure of claim 3, wherein the connecting plate is a magnetic connecting plate.

5. The LED fluorescent tube structure of claim 1, wherein the heat dissipating holder includes a cover to cover the light emitting plate for protection.

6. The LED fluorescent tube structure of claim 5, wherein the cover is a translucent cover.

7. The LED fluorescent tube structure of claim 1, further comprises a connector with a contact pin pair disposed on another side of the heat dissipating holder.

8. The LED fluorescent tube structure of claim 7, wherein the connector is detachably connected to the heat dissipating holder.

9. A LED fluorescent tube structure, comprising:
a heat dissipating holder;
a light emitting plate, disposed in and contacted to the heat dissipating holder;
a driver module, detachably disposed on one side of the heat dissipating holder and electrically connected to the light emitting plate; and
two connectors, with a contact pin pair respectively and disposed on both sides of the heat dissipating holder.

10. The LED fluorescent tube structure of claim 9, wherein the driver module further includes a fastening element for detachably connection to the heat dissipating holder.

11. The LED fluorescent tube structure of claim 9, wherein the light emitting plate includes a connecting plate to connect and contact to the heat dissipating holder.

12. The LED fluorescent tube structure of claim 11, wherein the connecting plate is a magnetic connecting plate.

13. The LED fluorescent tube structure of claim 9, wherein the heat dissipating holder includes a cover to cover the light emitting plate for protection.

14. The LED fluorescent tube structure of claim 13, wherein the cover is a translucent cover.

15. A LED fluorescent tube structure, comprising:
a heat dissipating holder;
a light emitting plate, disposed in and contacted to the heat dissipating holder; and
two connectors, with a contact pin pair respectively and disposed on both sides of the heat dissipating holder and electrically connected to the light emitting plate.

16. The LED fluorescent tube structure of claim 15, wherein the light emitting plate includes a connecting plate to connect and contact to the heat dissipating holder.

17. The LED fluorescent tube structure of claim 16, wherein the connecting plate is a magnetic connecting plate.

18. The LED fluorescent tube structure of claim 15, wherein the heat dissipating holder includes a cover to cover the light emitting plate for protection.

19. The LED fluorescent tube structure of claim 18, wherein the cover is a translucent cover.
